(19) United States
(12) Patent Application Publication
(10) Pub. No.: US 2006/0002420 A1
(43) Pub. Date: Jan. 5, 2006

(54) Tapped patch panel

(76) Inventor: Craig E. Foster, Santa Cruz, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/169,506

(22) Filed: Jun. 29, 2005

Related U.S. Application Data
(60) Provisional application No. 60/583,772, filed on Jun. 29, 2004.

(51) Int. Cl. H04L 12/66

(52) U.S. Cl. 370/463

(57) ABSTRACT

Network taps, each of which includes a pair of couplers, are integrated into a patch panel to provide a low cost and efficient way to analyze data on a communications network. Each pair of couplers is associated with one of the directional links of the pair of directional links that constitute a bidirectional network. The pair of couplers split the data signals that are transmitted by the cables, constituting the link to be tapped, which are attached to the pair of couplers. A first portion of the data signal remains in the network link while a second portion of the data signal is diverted from the tap to a network analysis device. In this way data signals of the communications network are analyzed by network analysis devices without interrupting the transmission of data signals across the communications network.

### RELATED APPLICATIONS

This application claims the benefit of U.S. Provisional Patent Application Ser. No. 60/583,772, filed Jun. 29, 2004, which is incorporated herein by reference.

### BACKGROUND OF THE INVENTION

1. The Field of the Invention

The present invention relates generally to multi-channel high speed communications systems, methods, and devices useful in analyzing communications traffic. More particularly, embodiments of the present invention relate to systems and methods for integrating a patch panel with network taps.

2. The Relevant Technology

Computer and data communications networks continue to develop and expand due to declining costs, improved performance of computer networking equipment, and increased demand for communication bandwidth. Communications networks, including wide area networks (“WANs”), local area networks (“LANs”), and storage area networks (“SANs”) allow increased productivity and utilization of distributed computers or stations through the sharing of resources and the processing of data at the most efficient locations on the network. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As networks become more pervasive and complex, the need to obtain access to network data for purposes of testing, monitoring, and analysis has become increasingly important. For example, when a problem occurs on a network, a network administrator may need to capture or otherwise monitor network data to diagnose the problem and identify network components or conditions that may be responsible for the problem.

As communication networks have increased in number, size, and complexity, they have become more likely to develop a variety of problems that are increasingly difficult to diagnose and resolve. Moreover, the demands for network operational reliability and increased network capacity, for example, emphasize the need for adequate diagnostic and remedial systems, methods, and devices.

One technique for accessing network data is to break a network link by temporarily disconnecting an end of a link so that a network monitoring or analysis device can be placed in a position to access network data. Although breaking a network link and inserting a monitoring device provides access to network data, temporarily disconnecting a network link presents disadvantages within the network. For example, the temporary disruption of the network topology and the associated connectivity between network nodes when the link is broken represents a significant problem for the network, and in many situations, makes breaking of a network link undesirable.

In order to avoid breaking a network link and disrupting network topology, network taps are often used to access network data. Network taps are devices that are placed inline in a network link and then split, or tap, a data signal by diverting a portion of the signal away from the network link to a tap port where the signal can be transmitted to a network capture or analysis device. Network taps are typically positioned in a location in the network where the network problems are likely to be experienced. Regardless of whether a network tap is being used at a particular time by a network analysis device, network components at either end of the network link can communicate with each other as if the network tap were not present.

Although conventional network taps have significantly improved the ability of administrators and other to access network data, such network taps have typically been fixtures located at discrete points in a network. When a network tap is located in a position where data of interest can be accessed, the network tap generally performs well. However, as the topology of a particular network grows or changes, or if the number of conventional network taps is insufficient, network problems may arise in a location that is not serviced by a network tap. Furthermore, attempting to place a network tap on every link of a network is generally not feasible due to the size and expense of conventional network taps.

### BRIEF SUMMARY OF THE INVENTION

In view of the foregoing, and other problems in accessing network data, the present invention provides a low cost and efficient way to analyze data on a communications network through the use of network taps. In one embodiment of the invention, network taps, each of which includes a pair of couplers, are integrated into a patch panel. Each pair of couplers is associated with one of the directional links of the pair of directional links that constitute a bidirectional network. The pair of couplers split the data signals that are transmitted by the cables, constituting the link to be tapped, which are attached to the pair of couplers. A first portion of the data signal remains in the network link while a second portion of the data signal is diverted from the tap to a network analysis device. In this way data signals of the communications network are analyzed by network analysis devices without interrupting the transmission of data signals across the communications network.

These and other objects and features of the present invention will become more fully apparent from the following description and appended claims.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 illustrates a conventional patch panel of a communications network.

FIG. 2 illustrates a network tap integrated into a patch panel according ton an embodiment of the invention.

### DETAILED DESCRIPTION OF EXEMPLARY EMBODIMENTS OF THE INVENTION

Embodiments of the present invention concern systems and devices for analyzing network traffic in a low cost and efficient way by integrating network taps with a patch panel. A tap, which is integrated into a patch panel, includes a pair of couplers, each of which is associated with one of the directional links that together constitute a bidirectional network. The couplers split a portion of the data signals out of the associated links such that a network analysis device connected to the tap is able to access network data. An analyzer, connected to the patch panel, obtains incoming data from both of the directional components of the link and thereby assesses any problems present in the network.

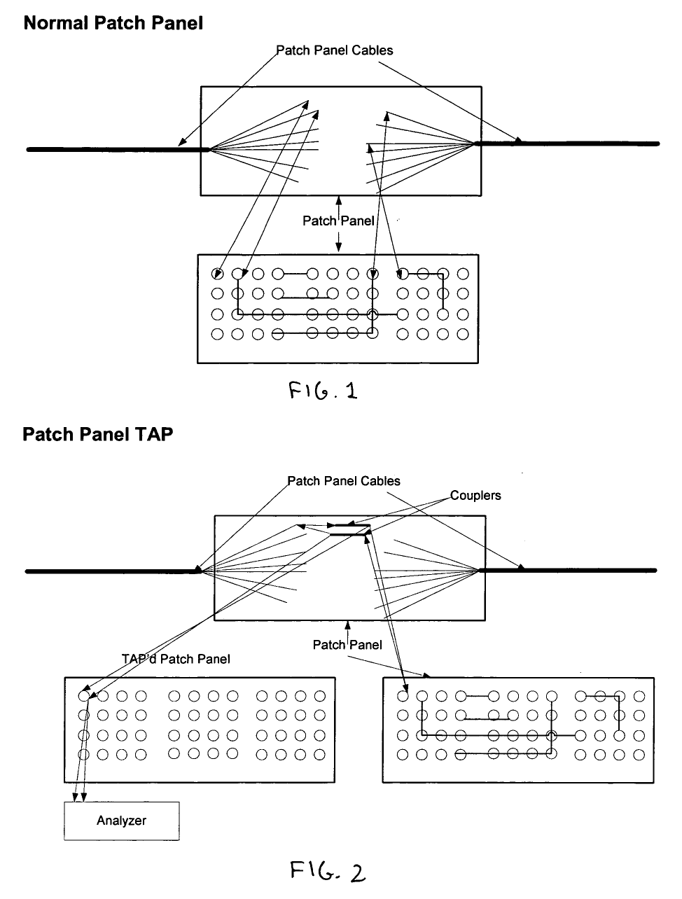

With attention now to FIG. 1, depicted is a block diagram that illustrates an exemplary conventional patch panel 100 of a communications network. Generally, a patch panel is a board configured to allow multiple network cables to connect to each other. Panel 102 shows a front view of patch panel 100, while panel 104 is an abstract illustration of how network cables are connected through patch panel 100. Network cables 106 are connected to elements of the network and enter the panel 104 from the left, while network cables 108, connected to additional elements of the network, enter the panel 104 from the right. Panel 102 shows how a patch panel is configured to provide access to a large number of ports 110 that can be used for various purposes, such as analyzing network communications traffic. A port is generally a specific place on a networked device for being physically connected to some other device, usually with a socket and plug of some kind. Ports 110 physically connect to the transmission cables of the network and can be used to assist in monitoring network traffic and capturing data of interest. Each of the network cables 106 and 108 is connected to one of ports 110 shown on the face of panel 102. Lines 112 show how each cable 106 and 108 corresponds to a specific port of patch panel 102. Thus, each of the cables 106 and 108 are connected through patch panel 100.

By connecting each of cables 106 and 108 through patch panel 100, network data and information can be efficiently transmitted throughout the communications network. Network data traveling through cables 106 is communicated to cables 108 through ports 110 of patch panel 100. Likewise, network data traveling through cables 108 is transferred to cables 106 through ports 110 of patch panel 100. Thus, all areas of the network connected through cables 106 and 108 are able to share data of the communications network.

In order to provide a low cost and efficient way to analyze data of the communications network, embodiments of the present invention integrate a network tap into a patch panel. A network tap is a device that is placed inline in a network link and splits (or taps) a data signal by diverting a portion of the signal away from the network link to a tap port where the signal can be transmitted to a network analysis device. An exemplary embodiment of a tap patch panel configuration is shown in FIG. 2. Patch panel configuration 200 includes three patch panels: normal patch panel 202, normal patch panel 204, and tapped patch panel 206. Each of normal patch panels 202 and 204 and tapped patch panel 206 include multiple ports 208 through which multiple network cables (not shown) are connected. Network cables are connected through normal patch panels 202 and 204 and tapped patch panel 206 as described in reference to network cables 106 and 108 and patch panel 100 of FIG. 1.

In one embodiment of the invention, normal patch panels 202 and 204 and tapped patch panel 206 are configured and arranged such that each of the normal patch panels 202 and 204 connect network cables (not shown) carrying network data. In such an embodiment tapped patch panel 206 is configured and arranged such that tapped patch panel 206 connects network cables carrying a read-only copy of the network traffic. In another embodiment, one of normal patch panel 202 and 204, and tapped patch panel 206, connect network cables carrying network data while the other of normal patch panel 202 and 204 connects network cables carrying a read-only copy of the network traffic. The patch panel connecting network cables carrying a read-only copy of the network traffic, which may be any one of normal patch panels 202 and 204 and tapped patch panel 206, is referred to herein as the copy patch panel.

The copy patch panel of patch panel configuration 200 connects to a network analysis device 210. In one exemplary embodiment shown in FIG. 2, network analysis device 210 is connected to tapped patch panel 206, which is the copy patch panel, through port 212 of tapped patch panel 206.

In operation, when a data signal is transmitted through network cables which interface with tapped patch panel 206 at port 212, network analysis device 210 obtains information transmitted through the cables. Network analysis device 210 uses the information obtained in this way to diagnose problems experienced in the network Z u and to locate possible sources of such network problems.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network communications system, comprising:
at least one patch panel having at least one port configured to connect one or more network cables, the network cables transmitting a data signal;
a tapped patch panel configured to connect one or more network cables and including couplers to split the data signal into one or more portions; and
a network analysis device configured to connected to the tapped patch panel, wherein the network analysis device receives and analyzes one of the one or more portions of the data signal.

2. The network communications system as recited in claim 1, wherein at least one of the one or more network cables connected to the tapped patch panel is tapped.

3. The network communications system as recited in claim 2, wherein the couplers are configured such that a pair of couplers connects to one of the one or more network cables that is to be tapped.
